(19) United States
(12) Patent Application Publication
(10) Pub. No.: US 2015/0179021 A1
(43) Pub. Date: Jun. 25, 2015

(54) SYSTEM AND METHOD FOR ALLOCATING PLAYING POSITIONS AMONG PLAYERS IN A SQUARES GAME

(71) Applicant: KIZZANG LLC, Las Vegas, NV (US)

(72) Inventor: Robert Alexander, Las Vegas, NV (US)

(21) Appl. No.: 14/137,475

(22) Filed: Dec. 20, 2013

(51) Int. Cl. G07F 17/32

(52) U.S. Cl. CPC G07F 17/3272; G07F 17/3244

(57) ABSTRACT

An on-line squares game allows players to compete for cash prizes based on point-qualifying activities (e.g., team scores) of a designated event (e.g., a sporting event), without said players being charged an entry fee for participating in the squares game. Players may select or are assigned to squares of a game board, each square being associated with a point pair representing points accumulated by competing teams in the designated sporting event on the basis of the point-qualifying activities thereof. The prizes are awarded to those players associated with squares having point pairs representative of an outcome of the point-qualifying activities of the designated sporting event. The point pairs, players and/or teams are assigned to the game board on the basis of outcomes of a pseudo-random number generator.

### FIELD OF THE INVENTION

The present invention relates to on-line gaming, and more specifically to methods and systems for conducting an on-line squares game that allocates participants (players) and scores in a random or pseudo-random fashion.

### BACKGROUND

Squares games are common form of wagering among friends, office co-workers and others. In the conventional squares game a 10×10 grid is drawn on a piece of paper, numerals are assigned to each row and column, teams (e.g., those engaged in a sporting contest, such as a football game) are assigned to each axis, and players are allowed to choose (“buy”) a square. In some instances the squares are purchased before the numbers (which represent digits in a corresponding team's score) are assigned to the rows and columns. The resulting game board 10 is similar to that illustrated in FIG. 1.

The numerals along the two orthogonal axes generally represent points. In the case of game board 10, Wolf owns the square corresponding to Team A scoring 1 point and Team B scoring 1 point. In the case of a football game, the points assigned to the squares in the grid are traditionally mapped to the last digit in a team's overall (i.e., final) score, but squares can be based on scores for a designated period of play between the teams (e.g., a quarter, half, etc.). Also, the points can be based on other events (e.g., just the number of first downs in a quarter, or a half, for example) and not just the team score.

### SUMMARY

In one embodiment, the present invention provides an on-line squares game in which players compete for cash prizes based on point-qualifying activities of a designated sporting event, without said players being charged an entry fee for participating in the squares game. Players may select or are assigned to squares of a game board, each square being associated with a point pair (e.g., intersecting point values associated with rows and columns of the game board) representing points accumulated by competing teams in the designated sporting event on the basis of the point-qualifying activities thereof. The prizes are awarded to those players associated with squares having point pairs representative of an outcome of the point-qualifying activities of the designated sporting event. The point pairs, players and/or teams are assigned to the game board on the basis of outcomes of a pseudo-random number generator.

### BRIEF DESCRIPTION OF THE DRAWINGS

The present invention is illustrated by way of example, and not limitation, in the figures of the accompanying drawings, in which:

FIG. 1 illustrates an example of a completed grid of a squares game.

FIG. 2 illustrates an example of a networked system having a server configured for providing an on-line squares game to one or more clients in accordance with embodiments of the present invention.

FIG. 3 illustrates an example of a process for execution by a server to conduct an on-line squares game in accordance with embodiments of the present invention.

FIG. 4 illustrates an example of a processor-based platform for execution of computer-executable instructions for conducting or playing an on-line squares game in accordance with embodiments of the present invention.

### DESCRIPTION

The present invention allows players to participate in an on-line squares game that allows players to compete for cash prizes based on scores or other point-qualifying activities of designated sporting events, such as football games, basketball games, baseball games, etc. Importantly, participants are not charged any entry fee for participating in the game. Players participate in the squares game by registering with a service offering the game and electing to participate. Prizes are awarded to players that are associated with point pairs (i.e., squares) representative of the outcome of the point-qualifying activities of the designated sporting events.

In one embodiment of the invention, players are afforded the opportunity to select a square of a game board. In other embodiments, game boards are populated left to right and top to bottom (or in some other fashion, e.g., randomly or pseudo-randomly) as players enter. As additional players enter, new game boards are created automatically and so long as one player is assigned a square in a game board, the board is considered valid for purposes of awarding a prize, in some instances a cash prize. In other instances, players may compete for entertainment, without the necessity of prizes being awarded. In some embodiments, points are assigned to the squares before they are selected by a player or populated upon player entry, while in other embodiments the points are assigned to squares only after an entire game board is populated or, in the case of a less than fully-populated game board, after the time for entry into the contest has expired. In some instances, players enter the contest but are not shown their square or its corresponding points until after the time for entry into the contest has expired. Often, this will be immediately prior to or coincident with commencement of the subject sporting event (or portion thereof to which the squares game is concerned), although in some cases contest entries may close some period of time in advance of the commencement of the underlying sporting event (or portion thereof).

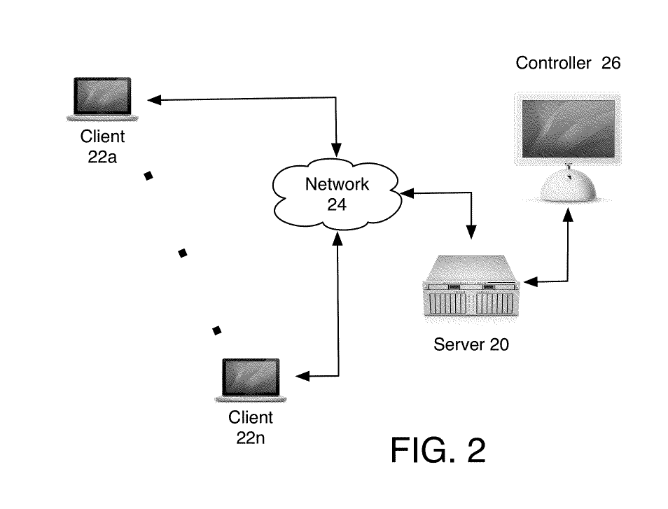

In some embodiments of the invention, selecting a square of a game board made by activating graphical user interface elements such as sliders, check boxes, radio buttons, or any other means of designating a selection. Referring to FIG. 2, a server 20 is configured to communicate with one or more client computers 22a-22n via network 24 (e.g., the Internet) to provide players associated with the client computers access to a squares game hosted on server 20. Of course, to facilitate access by hundreds or even thousands of client computers, server 20 may be a server farm with appropriate load balancers so as to provide each player with a satisfactory gaming experience that involves minimal latency. Instances of server 20 are configured by a contest organizer, for example via controller 26, to provide the same game to all players who participate in the contest. Notification of the contest, the rules, playing conditions, etc., may be provided to individual players upon such players' logging in to a respective account, through which the players may access the contest if and when they choose to do so.

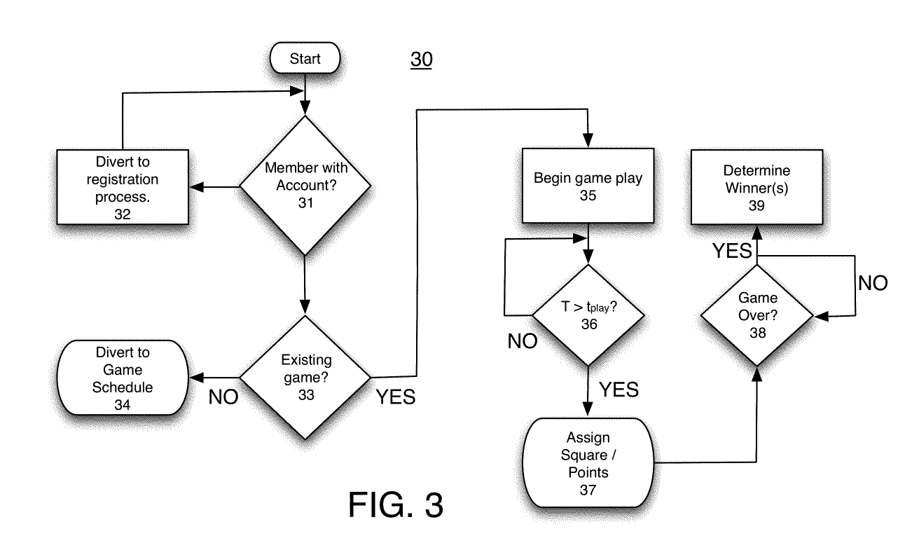

FIG. 3 shows an example of a process 30 executed by server 20 when a player at a client 22 connects to the server. At 31, the server may execute a process to determine whether the player is a member that has an account with the service. This may be done by running a log-in or similar script that requires the user to enter log-in credentials for the service. If the player is not a member of the service, the player may be diverted to a registration process 32, which provides the player with an opportunity to become a member. This may involve the player providing certain personal information, including, for example, information sufficient to establish that the player is of legal age to play in games of the kind offered through the service. Although shown as an in-line process, obtaining membership in the service may be a separate process that requires some time to complete, as for example where verification of the member's age, etc. is required through secondary sources.

If the server determines that the player is a member of the service 31, the server determines whether there is an existing squares game in which the player can play 33. This is essentially a check of whether the time for a squares game is within a period tₛₜₐᵣₜ and t_{end}. If not, the player may be diverted to a schedule 34 that provides information regarding upcoming game dates/times. If, however, a squares game is open for participation, the player is provided an opportunity to begin game play 35.

Players are permitted to enter the squares game until the time for such entry into the contest has expired 36. At that time, if player squares and/or points associated with the squares on a game board have not been assigned, those assignments are made 37. Assignments of players to squares of a game board and assignments of points to the columns and rows of a game board may be made in any of several fashions:
1. Players may be assigned to game board squares on a first come, first served basis in which players are permitted to pick their own squares with knowledge of the points assigned to those squares and the teams assigned to the row and column of the game board.
2. Players may be assigned to game board squares on a first come, first served basis in which players are permitted to pick their own squares but without knowledge of the points assigned to those squares and/or the teams assigned to the row and column of the game board. Teams may be assigned based on the outcome of a random or pseudo-random event, such as the output of a pseudo-random number generator. Likewise, pints may be assigned to squares based on the outcome of a random or pseudo-random event, such as the output of a pseudo-random number generator. For example, to populate the points along an edge of the 10×10 grid, a starting position corresponding to one of the rows or columns is selected and a pseudo-random number generator included as part of or accessible by server 10 is invoked to provide outputs. The outputs are scaled, truncated or otherwise resolved to a single numerical digit and that digit is assigned to the subject position in the row/column of the grid. The next position in the row/column of the grid is selected and the process repeats. This continues until all of the row/column positions within the 10×10 grid have assigned point pair values.
3. Players may be assigned to game board squares on a random or pseudo-random basis in which players are not permitted to pick their own squares. In such an embodiment assignment of a player to a square may be made before or after points are assigned to the rows and columns of the game board and/or before or after assignment of the teams to the rows and columns of the game board. Player assignments may be determined by assigning each player for a game board a virtual lot and selecting lots until the game board is filled through comparison of the lots with a number generated by a random or pseudo-random number generator. For example, player lots may be assigned (e.g., in linear or other fashion) based on the date/time that a player enters the contest and prior to commencement of the underlying sporting event a pseudo-random number generator included as part of or accessible by server 10 may be invoked to provide outputs. The outputs of the pseudo-random number generator are compared to the player lots and the closest remaining one of the lots of players not yet assigned to a square on the game board is selected and the corresponding player assigned to a square. The square to be so populated may be chosen in a similar fashion or the squares may be populated on a different basis, such as left-to-right and top-to-bottom, vice-versa, or according to another known pattern.
4. Players may be assigned to game board squares on a random or pseudo-random basis in which players are not permitted to pick their own squares, such as that described above, and the points and/or teams associated with the squares may be similarly assigned on a random or pseudo-random basis.
   Other methods of assigning players to squares of a game board and/or assigning points and/or teams to the columns and rows of a game board may also be made.

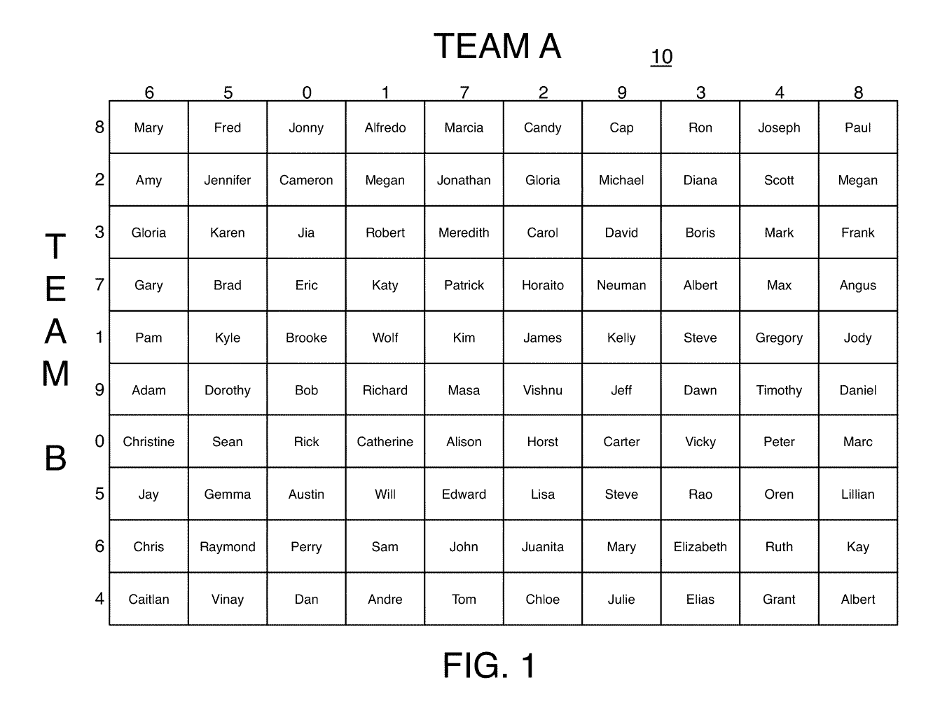

A completed game board may resemble game board 10 illustrated in FIG. 1, and players participating in the contest may be provided a copy of their game board once it has been populated (or earlier, for example when the player's square has been assigned). For example, the game board may be made available for viewing at server 10 and/or copies thereof may be sent to individual players via email, text message or other means. In some cases, advertisers may sponsor game boards and players may be required to view advertisements prior to being permitted to enter a game and/or view a game board. Likewise, copies of game boards provided to players may be embossed or otherwise adorned with advertisements of one or more sponsors. As indicated above, partially populated game boards are permitted and a game board is considered eligible for awards of cash prizes so long as a single square therein is populated by a player.

After a game board has been populated, and the underlying sporting event has concluded (or the portion of the underlying sporting event for which the squares game is relevant has concluded) 38, server 10 (which is provided information concerning the sporting event, such as the score, etc.) analyzes the game boards and determines the winner(s) 39. The winners are those players that have squares on the game board corresponding to the points accumulated by each team in the underlying sporting event. For example, and referring to FIG. 1, if the underlying sporting event is a football game and the final score of the game is team A 28, team B 17, then team A's score represents 8 points, team B's score represents 7 points and Angus is the winner of the squares game. Server 20 may then generate one or more notification messages for Angus (not shown), such as email, text or other messages, and Angus will receive his cash prize.

Preferably, the server 20 logs information concerning a number of aspects of the squares game, For example, logs that indicate which players participated in a game, which game board a player was associated with, the points associated with the player's assigned square, the points or other values accorded the teams playing in the underlying sporting event, etc. So too are logs of all player winning Logs that record technical faults, communication problems, etc. that may become the subject of a complaint or may be grounds for providing repeat play opportunities are also kept.

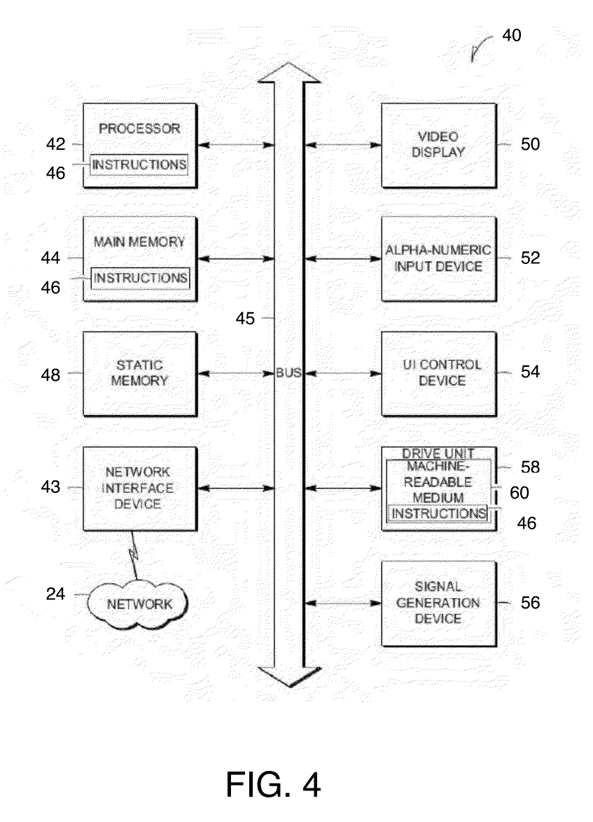

As evident from the foregoing discussion, one or more of the methods or processes described herein may be executable on various computer-based devices (e.g., clients 22 and/or server 20). Such devices, an example (40) of which is illustrated in FIG. 4, may include any electronic device capable of performing the actions described above (using suitable programming) and, where applicable, processing the information for display so as to properly convey the information. Examples of such devices include desktop computers, laptop computers, cellphones, smart phones, tablet computers, computer game consoles, portable computer gaming consoles, media players, portable media players, other mobile devices, and the like.

In such devices, a processor 42 may control the overall functions of the electronic device such as running applications and controlling peripherals. Such a processor may be any type of processor and may communicate with network interface device 43, e.g., via bus 45, to transmit and receive signals (e.g., cellular, Bluetooth, Wi-Fi, WiLAN, or other communication signals) over a network 24. The processor may use main memory 44 and/or a cache to store operating instructions 46 and to help in the execution of the operating instructions (e.g., such as the temporary storage of calculations and the like). The processor may also use non-transitory storage 48 and/or long-term storage 58 (such as a flash drive, hard disk or other unit comprising a tangible machine readable medium 60) to store and read instructions, files, and other data that requires long term, non-volatile storage.

The processor may communicate and control other peripherals, such as a display 50 with associated touch screen sensor, causing images to be displayed on the display and receiving input from the touch screen sensor when a user presses on the touch-screen display. In some examples, a touch screen sensor may be a multi-touch sensor capable of distinguishing and processing gestures.

The processor may receive input from a physical keyboard 52 and/or mouse/touch pad 54. In other examples, the device may utilize a touch screen keyboard using the display and touch screen sensor. The processor may produce audio output and other alerts that are played on a speaker or other signal generation device 56. A microphone (not shown) may be used as an input device for the processor to receive commands using voice-processing software. In the case of a client 12, an accelerometer may provide input on the motion of the device to the processor. An accelerometer may be used in motion sensitive applications, or, for example, in connection with scrolling content using tilting gestures, etc.

A Bluetooth module may be used to communicate with Bluetooth-enabled external devices. A USB port may enable external connections to other devices (e.g., mice or other cursor control devices) supporting the USB standard and charging capabilities. An external storage module may include any form of removable physical storage media such as a flash drive, micro SD card, SD card, Memory Stick, and the like.

Certain embodiments are described herein as including logic or a number of components, modules, or mechanisms. Modules or components may constitute software modules (e.g., code embodied on a non-transitory machine-readable medium) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules may provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connects the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but also deployed across a number of machines. In some example embodiments, the processor or processors may be located in a single location, while in other embodiments the processors may be distributed across a number of locations.

The one or more processors may also operate to support performance of the relevant operations in a “cloud computing” environment or as a “software-as-a-service” (SaaS) service. For example, at least some of the operations may be performed by a group of computers (as examples of machines including processors), with these operations being accessible via a network (e.g., the Internet) and via one or more appropriate interfaces (e.g., Application Program Interfaces (APIs).)

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program may be written in any form of programming language, including compiled or interpreted languages, and it may be deployed in any form, including as a stand-alone program or as a module, subroutine, or other unit suitable for use in a computing environment. A computer program may be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations may also be performed by, and apparatus of example embodiments may be implemented as, special purpose logic circuitry, e.g., a field programmable gate array (FPGA) or an application-specific integrated circuit (ASIC).

The foregoing description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” and the like are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. For example, the code can be stored on one or more non-transitory, or non-volatile tangible computer-readable media, and may be loaded into volatile media during execution or at other times (e.g., during a transfer between storage devices, etc.). Examples of these tangible computer-readable media can include, but are not limited to, hard disks, removable magnetic disks, removable optical disks (e.g., compact disks and digital video disks), magnetic cassettes, memory cards or sticks, read only memories (ROMs), flash memories or other solid state devices (SSDs) and the like.

What is claimed is:

1. A processor-based system comprising a processor and a storage device communicably coupled to the processor, the storage device storing processor-executable instructions, which instructions, when executed by the processor, cause the processor to host, for participation by one or more players, an on-line squares game in which said players compete for cash prizes based on point-qualifying activities of a designated sporting event, without said players being charged an entry fee for participating in the squares game, and in which squares game players are assigned to squares of a game board, each square associated with a point pair representing points accumulated by competing teams in the designated sporting event on the basis of the point-qualifying activities of the designated sporting event and said prizes are awarded to players that are associated with squares having point pairs representative of an outcome of the point-qualifying activities of the designated sporting event, wherein one or more of the point pairs, players and/or competing teams are assigned to the game board according to outcomes of a pseudo-random number generator.

2. The processor-based system of claim 1, where the point pairs, players and/or teams are assigned to the game board immediately prior to commencement of the designated sporting event.

3. The processor-based system of claim 1, where the point pairs, players and/or teams are assigned to the game board immediately prior to or coincident with commencement of a portion of the designated sporting event to which the squares game is concerned.

4. The processor-based system of claim 1, where the point pairs, players and/or teams are assigned to the game board coincident with commencement of the designated sporting event.

5. The processor-based system of claim 1, where the point pairs, players and/or teams are assigned to the game board coincident with commencement of a portion of the designated sporting event to which the squares game is concerned.

6. A method, comprising:
providing, by a processor-based system, for participation by one or more players, an on-line squares game in which said players compete for cash prizes based on point-qualifying activities of a designated sporting event;
receiving, by the processor based system, player entries into the on-line squares game without said players being charged an entry fee for participating in the squares game, wherein the player entries are received at the processor based system from one or more client systems communicatively coupled to the processor-based system via a network;
assigning, by the processor-based system, squares of a game board to players that have entered the squares game, each square in each game board being associated with a point pair representing points accumulated by competing teams in a designated sporting event on the basis of point-qualifying activities of the designated sporting event; and
upon completion of the designated sporting event, the processor-based system designating a winner of the on-line squares game, said winner being one or the players that is associated with a square of the game board having point pairs representative of an outcome of the point-qualifying activities of the designated sporting event,
wherein one or more of the point pairs, players and/or competing teams are assigned to the game board according to outcomes of a pseudo-random number generator.

7. The method of claim 6, further comprising awarding a prize to the winning player.
